(19) United States
(12) Patent Application Publication
(10) Pub. No.: US 2010/0296771 A1
(43) Pub. Date: Nov. 25, 2010

(54) Evanescent Field Optical Fiber Devices

(75) Inventors: Eric Weynant, Outremont (CA); Alex Fraser, St-Romuald (CA)

Correspondence Address: Sunstein Kann Murphy & Timbers LLP, 125 SUMMER STREET, BOSTON, MA, 02110-1618, US

(73) Assignee: PHASOPTX INC., Montreal, QC (CA)

(21) Appl. No.: 12/678,672

(22) PCT Filed: Sep. 18, 2008
(86) PCT No.: PCT/CA2008/001652

§ 371 Date: Aug. 10, 2010

Related U.S. Application Data
(60) Provisional application No. 60/973,264, filed on Sep. 18, 2007.

(51) Int. Cl. G02B 6/00; G02B 6/26

(52) U.S. Cl. 385/13; 385/30; 385/37

(57) ABSTRACT

The present invention is directed to an evanescent field optical fiber device including one or more optical fibers and a support which assures mechanical strength of the optical fiber wherein one or more grooves has been machined in the support and in the coating of the one or more optical fiber in order to gain access to the evanescent field. The invention is also directed to the use of a support in the mechanical and chemical removal of coating from an optical fiber and a method of gaining access to the evanescent field of an optical fiber device.

### FIELD OF THE INVENTION

The present invention relates to evanescent field optical fiber devices, including optical fiber sensors.

### BACKGROUND OF THE INVENTION

Evanescence based fiber optic sensors have received considerable attention in the past years due to their widespread applications in various parameter measurements such as temperatures, pressures and of biological and chemical materials that may be present in an environment or sample of interest.

Various techniques, well known in the art, have been developed to access the evanescent field in an optical fiber. For example, an optical fiber may be tapered by stretching it while it is heated, e.g. over a flame. Another technique is by polished coupler in a glass block to protect the optical fiber during the grinding and polishing steps. A third technique entails removal of a portion of the cladding by mechanical or chemical means. However, when a portion of the cladding of an optical fiber is removed to access the evanescent field, the fiber already of minute diameter is increasingly more fragile and delicate. Although the third technique may be carried out in very specialized circumstances such as in a laboratory, it is very difficult to manufacture and difficult to use.

Therefore, there is a need for improved techniques for use of optical fibers as components of optical sensors and such sensors that have good mechanical resistance and, of course, that are easy to use and to manufacture. Such a need also exists for improved techniques for use of optical fibers in components of systems using optical fibers, such as optical fiber communications systems, including couplers, splitters, repeaters, switchers, amplifiers, attenuators, isolators and the like.

One approach for optical sensors is described in U.S. patent application 2004/0179765 in which an optical fiber is coupled or connected to a larger optical waveguide in which a portion of the cladding, and optionally the core, has been removed using any suitable known techniques in the art, to permit access to the evanescent field. However, to be put into practice, this type of sensing device requires an alignment or axial coupling of two or more optical fibers with a separate optical waveguide of far larger diameter. This step is not only complex but also requires very precise alignment in order to minimize the loss of light energy.

Thus, it is desired to improve on evanescence based fiber optic sensors, having a good mechanical resistance with improved durability and ease of assembly and use.

### SUMMARY OF THE INVENTION

The present invention reduces the difficulties and the disadvantages of the prior art by reinforcing an optical fiber itself without, for example, the need of connecting the latter to another optical waveguide.

The present invention relates to an evanescent field optical fiber device comprising one or more optical fibers wherein a portion of said one or more fibers is without coating, and a support which provides for the mechanical integrity of the one or more optical fiber and for access of the evanescent field without impairing the optical fiber.

More particularly, the present invention provides an evanescence based optical fiber device comprising one or more optical fibers as above and a support which assures mechanical strength of the optical fiber wherein one or more grooves has been machined in the support and in a cladding portion of the one or more optical fibers in order to gain access to the evanescent field.

In a further embodiment, the present invention relates to the use of a support in the mechanical or chemical removal of cladding from an optical fiber for use in an evanescence based fiber optic device.

Another embodiment is the method of using the support for the mechanical or chemical removal of cladding from an optical fiber for use in an evanescence based fiber optic device.

A further embodiment of the present invention is such a support for one or more optical fibers or such optical devices, comprised of shape memory material.

### BRIEF DESCRIPTION OF THE DRAWINGS

In order that the invention may be more readily understood, currently preferred embodiments will now be further described by way of example with reference to the accompanying drawings in which:

FIG. 1 is an isometric view of the support of the present invention;

FIG. 2 is an isometric view of an evanescent field optical fiber sensor that has an optical fiber, a support and a groove machined in the support and in a cladding portion of the optical fiber;

FIG. 3 is a side view of an evanescent field optical fiber sensor that has an optical fiber, a support and a groove machined in the support and in a cladding portion of the optical;

FIG. 4 is an isometric view of an evanescent field optical fiber sensor that has an optical fiber, a support and a groove machined in the support and in a cladding portion of the optical fiber and wherein the groove is an axial groove;

FIG. 5 is an isometric view of the evanescent field optical fiber sensor that has an optical fiber, a support and a groove machined in the support and in a cladding portion of the optical fiber and wherein a thin layer of substrate has been applied on the exposed cladding portion;

FIG. 6 is an isometric view of the evanescent field optical fiber sensor that has an optical fiber, a support and a groove machined in the support and in a cladding portion of the optical fiber and wherein thin layers of metal and substrate have been applied on the exposed cladding portion;

FIG. 7 is an isometric view of an evanescent field optical fiber sensor that includes a responsive layer between two exposed cladding portions of the evanescent field optical fiber sensors of the present invention;

FIG. 8 is a cross-sectional view of FIG. 7;

FIG. 9 is a top plan view of the evanescent field optical fiber sensor comprising two optical fibers in one support and a plasmonic guide;

FIG. 10 is a side view of FIG. 9;

FIG. 11 is a side view of FIG. 9;

FIG. 12 is a side view of an evanescent field optical fiber sensor based on reflection design;

FIG. 13 is s side view of an evanescent field optical fiber sensor based on transmission design;

FIG. 14. is a side view of an evanescent field optical fiber sensor based on reflection design with Bragg grating; and

FIG. 15 is a side view of 3 evanescent field optical fiber sensors with Bragg grating branched in series.

### DETAILED DESCRIPTION OF THE INVENTION

The present invention is based on a particular use of devices as a support for optical fibers in optical fiber devices, such as optical fiber sensors, couplers, splitters, repeaters, switchers, amplifiers, attenuators, isolators and the like. Such devices are of the type as described in U.S. Patent Nos. 7,066,656 and 7,121,731, and WO 2005/040876 published May 6, 2005. A skilled person would understand that the optical fiber will generally comprises at least one core, a cladding and a protective coating layer. For simplicity, we refer herein to cladding only, but it will be understood that when discussing the removal of cladding for the purpose of practicing the present invention, this will include the removal of any other coating on an optical fiber, as may be necessary.

The present invention is herein described in more detail in an embodiment relating to optical fiber sensors, although a skilled person will readily appreciate and be able to put into practice other embodiments of the invention as described herein and based on the following teachings.

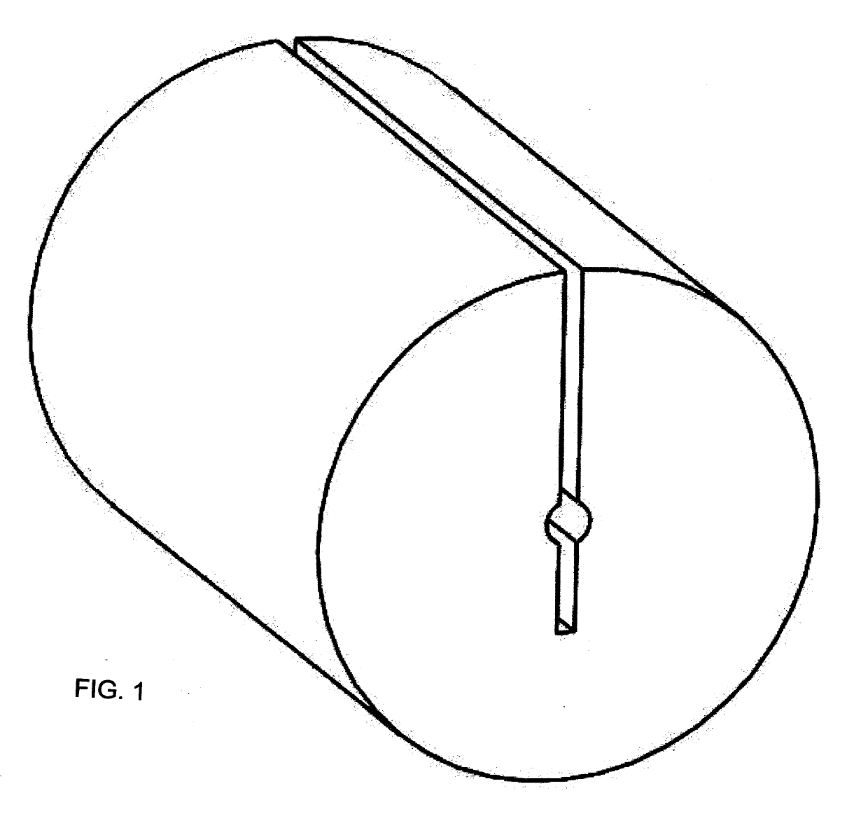

Referring to FIG. 1, the connector has a longitudinally extending body which may be generally cylindrical. Consequently, for the purpose of this invention, this connector will be named a support. Indeed, although the support is shown here as cylindrical, it may be of any shape which is suitable for such a support. The body of the support has a first end and a second end. The body has a fiber conduit extending from the first end to the second end. The fiber conduit which is shown here as round may be of any shape suitable for insertion of optical fibers. Further, the support may have a plurality of fiber conduits depending on the number of optical fibers to insert. The diameter of the fiber conduit is slightly smaller than the sized of the optical fiber. The fiber conduit of the support is used to embrace an optical fiber in order to protect and to provide an adequate mechanical resistance to the optical fiber that permit access to the evanescent field without impairing the integrity of the optical fiber. In one embodiment, the support of the present invention has at least one longitudinal slot extending from the first end to the second end and from the surface of the support to the fiber conduit to allow the expansion of the fiber conduit for insertion of an optical fiber. However, it will be understood that the support can be of any suitable design for retention of an optical fiber in the conduit and can be of the kind of design as, for example, shown in the aforementioned U.S. Patent Nos. 7,066,656 and 7,121,731, and WO 2005/040876 published May 6, 2005, Of course, a skilled person in the art will appreciate an be able to carry out any necessary mechanical modifications as may be necessary to the devices as described above for better use as a support as defined herein.

The support of the present invention may be made of any of several materials depending on its use and on the particular environment in which the support is used. For example, the support of the present invention may be made from a shape memory material. For the purposes of the present application, with respect to shape memory material (SMM), reference may be made to AFNOR Standard “Alliages à mémore de former—Vocabulaire et Mesures” A 51080-1990.

Materials, which are suitable for the support of the present invention, will illustrate a very low Young's modulus (elastic modulus) and/or pseudo elastic effect. Pseudo elastic effect is encountered in SMM. Concerning the shape memory effect, when the material is below a temperature (M_{F}), which is a property dependent on the particular SMM, it is possible to strain (deform) the material from about some tenths of a percent to more than about eight percent, depending on the particular SMM used. When the SMM is heated above a second temperature (A_{F}), which is also dependent on the particular SMM as well as the applied stress, the SMM will tend to recover its assigned shape. If unstresses, the SMM will tend toward total recovery of its original shape. If a stress is maintained, the SMM will tend to particularly recover its original shape. Concerning the pseudo elastic effect, when the SMM is at a temperature greater than its (A_{F}), it may be strained at particularly higher rates, that is exhibiting non-used elasticity, arising from the shape MEMORY properties. Initially, in the SMM when stressed the strain will increase linearly, as in a used elastic material. However, at an amount of stress, which is dependent on the particular SMM and temperature, the ratio of strain to stress is no longer linear, strain increases at a higher rate as stress is increasing at a lower rate. At a particular higher level of stress, the increase in strain will tend to become smaller. This non-linear effect exhibited by SMM a temperature above (A_{F}) may manifest itself as a hysteresis like effect, wherein on the release or reduction of stress the reduction in strain will follow a different curve from the one manifest as stress was increased, in the manner of a hysteresis like loop.

An example of such above material would be a shape memory alloy (SMA). Examples concerning activation of the shape memory element in a SMA include D.E. Muntges et al., “Proceedings of SPIE”, Volume 4327 (2001), pages 193-200 and Byong-Ho Park et al., “Proceedings of SPIE”, Volume 4327 (2001), pages 79-87. Miniaturized components of SMA may be manufactured by laser radiation processing. See for example, H. Hafer Kamp et al., “Laser Zentrum Hannover e.v.”, Hannover, Germany [publication].

The support of the present invention may, for example, be made from a polymeric material such as isostatic polybutene, shape ceramics such as zirconium with some addition of Cerium, Beryllium or Molybdenum, copper alloys including binary and ternary alloys, such as Copper-Aluminum alloys, Copper-Zinc alloys, Copper-Aluminum-Beryllium alloys, Copper-Aluminum-Zinc alloys and Copper-Aluminum-Nickel alloys, Nickel alloys such as Nickel-Titanium alloys and Nickel-Titanium-Cobalt alloys, Iron alloys such as Iron-Manganese alloys, Iron-Manganese-Silicon alloys, Iron-Chromium-Manganese alloys and Iron-Chromium-Silicon alloys, Aluminum alloys, and high elasticity composites which may optionally have metallic or polymeric reinforcement.

In use, the fiber conduit is enlarged by deforming the support of the present invention in any suitable way. Without limitation, an optical fiber may be inserted into and positioned in the support in any manner as described in the aforementioned U.S. Patent Nos. 7,066,656 and 7,121,731, and WO 2005/040876 published May 6, 2005, for the purpose of practicing the present invention. For example and generally, a constraint is applied to the support which will induce an expansion of the fiber conduit for insertion of an optical fiber. Removal of the constraint will allow retention of the optical fiber within the fiber conduit of the support which then applies a uniform radial pressure along the fiber. At this stage, a portion of the cladding of the optical fiber can be safely removed for accessing the evanescent field by any known techniques in the art as, for example, mechanically or by chemical means, the mechanical resistance of the optical fiber being now adequately secured.

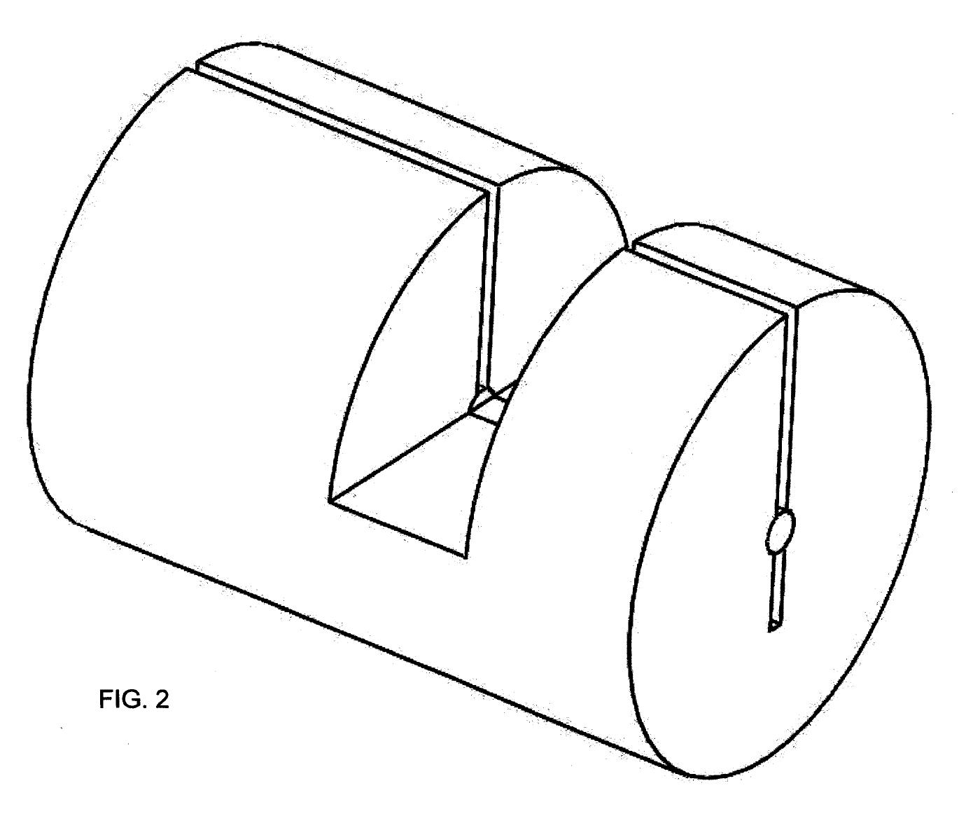

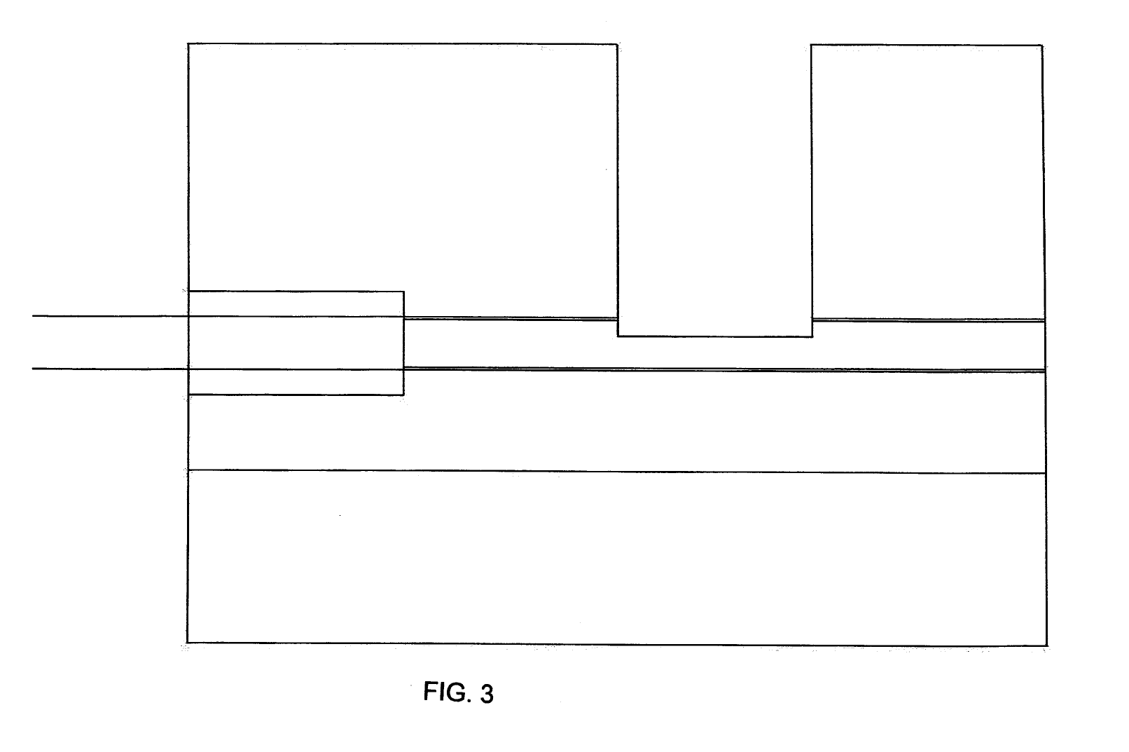

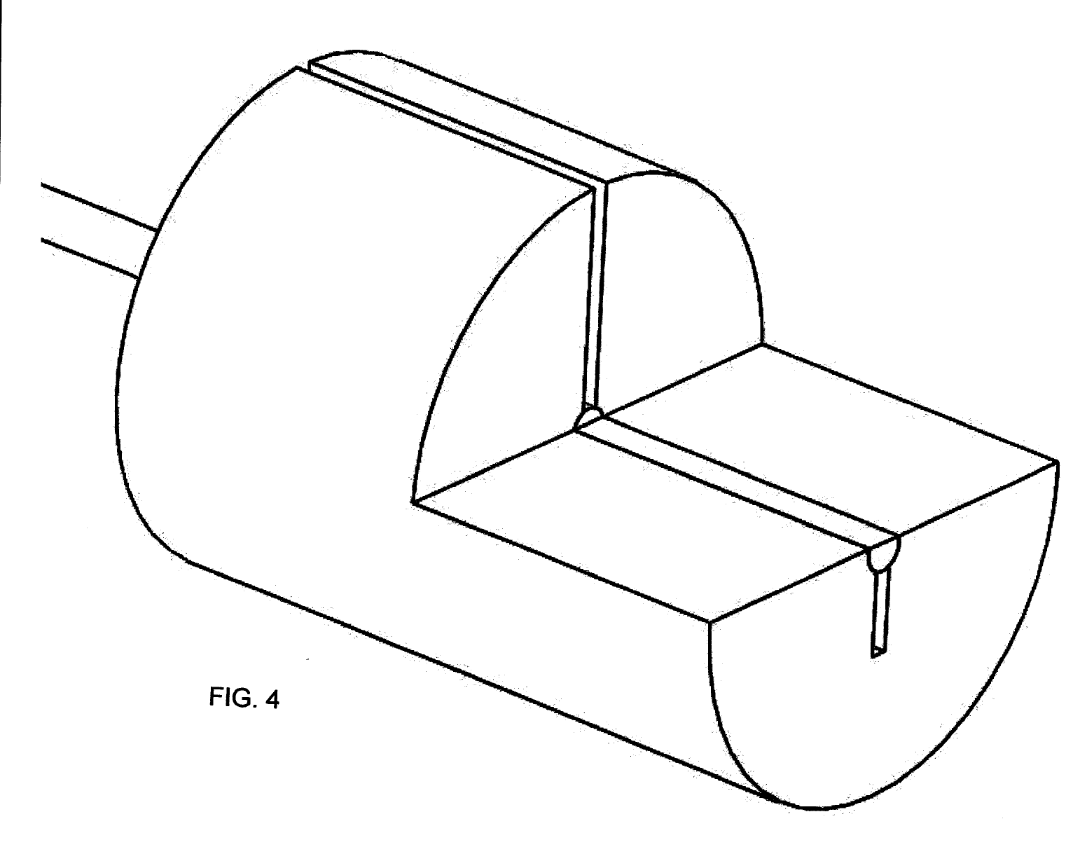

There are several manners to use the support of the present invention in relation with an optical fiber in order to have access to the evanescent field, for use an evanescent field optical sensor and for the making of such evanescent field optical sensor. For example, as shown in FIGS. 2 and 3, it is possible to machine, by any suitable techniques known in the art, a groove in the support before or after the insertion of an optical fiber. If the groove in the support is machined before insertion of an optical fiber, then, the optical fiber will be further machined using any suitable techniques known in the art by accessing the cladding of the optical fiber within the groove of the support. It will be further understood that a portion of the cladding can be removed by any other known means including by chemical means. It will be appreciated that the present invention does not require removal of all of the thickness of the cladding from a portion of the fiber. In practice, only a portion of the thickness of the cladding may be removed and only a part of it retained in the exposed portion. Moreover, the groove may also be formed axially as shown in FIG. 4.

Furthermore, in order to obtain a high-quality sensor, the portion removed from the cladding of the optical fiber maintained by the support may be further polished by any suitable techniques known in the art as, for example, by the use of a CO2 laser as described in Nowak (Nowak, K. M. (2006) .

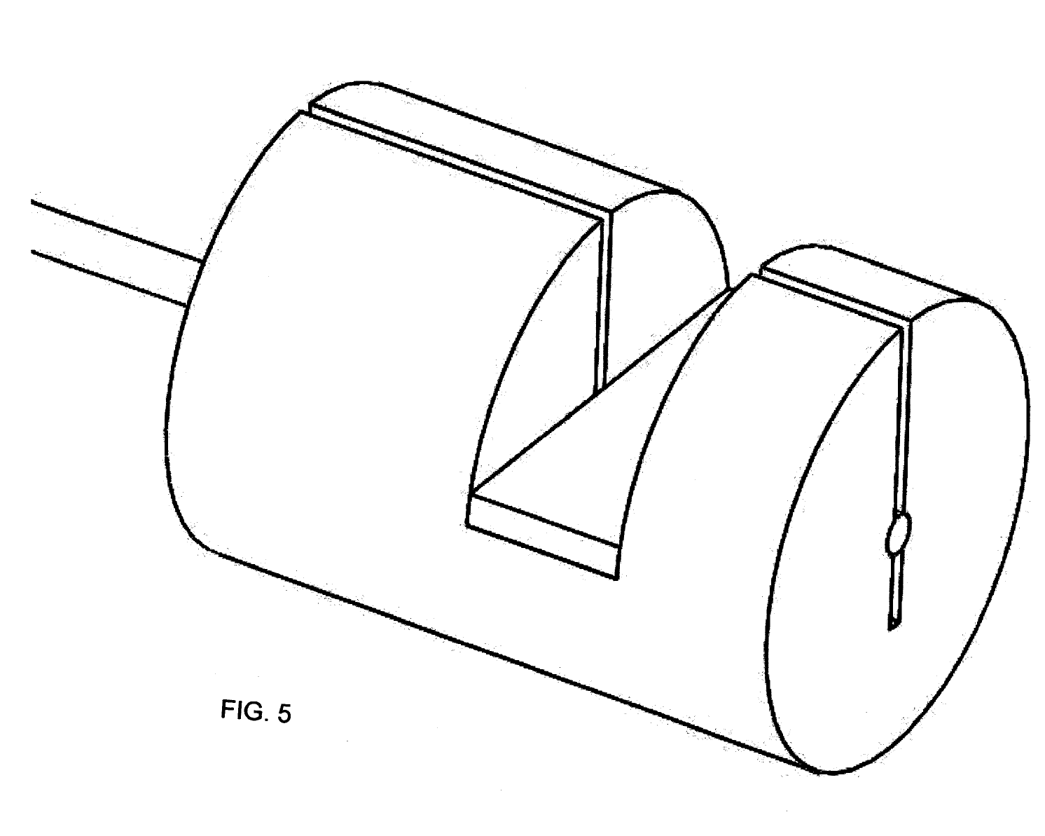

After polishing the exposed cladding portion of the optical fiber, it is possible to apply a substrate in a manner known in the art on the polished surface of the optical fiber which shows a substantial variation of its refractive index in relation with the parameter to measure (temperature, pressure, shear, concentration of a particular chemical, presence and concentration of an agent, etc). This is well demonstrated in FIG. 5. For example, with respect to a temperature sensor, the elected substrate will have to present a large thermal dilation for a given range of temperatures to measure. This density variation will cause a change of the refractive index which will modify the measured signal. The analysis of this signal will allow to measure precisely the studied parameter.

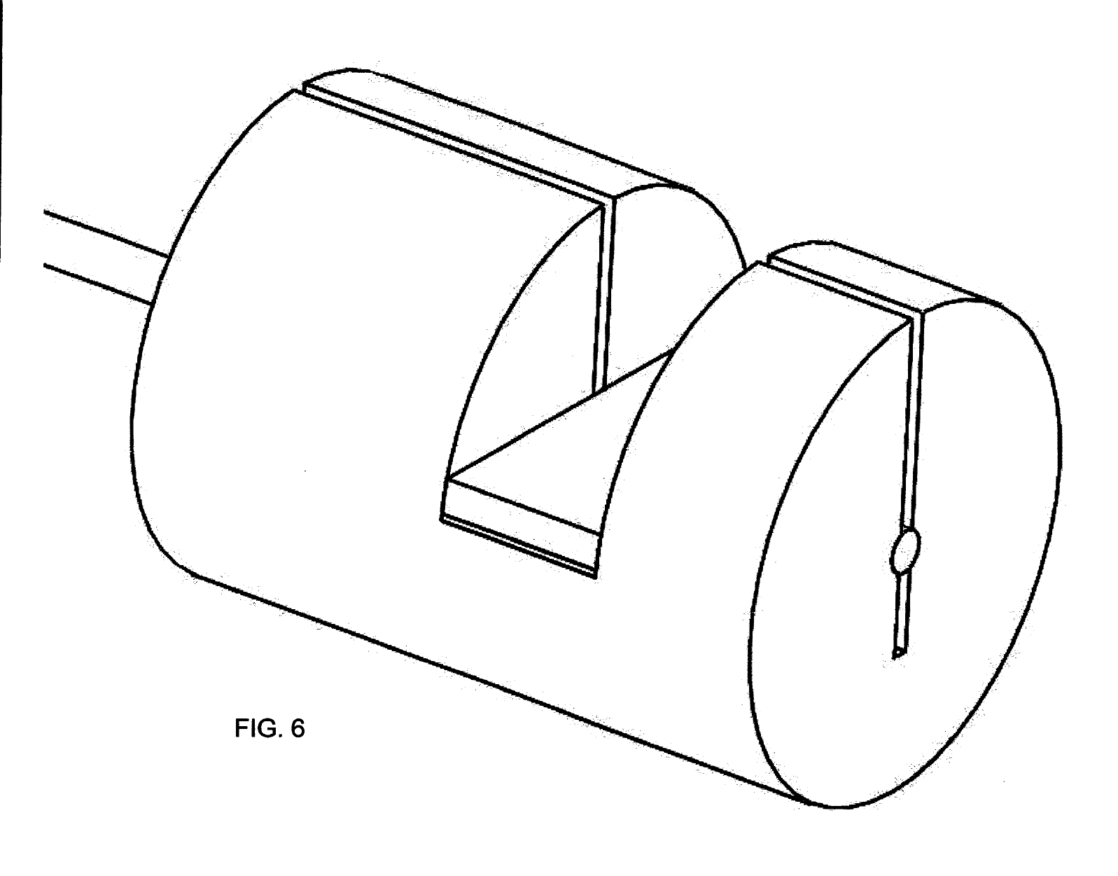

In order to increase the absorption of the substrate and improve the precision of the sensor, one could add a thin layer of metal (few nanometers of thickness) over the polished surface of the exposed cladding before applying the substrate. This is clearly shown in FIG. 6. The energy transmitted in the optical fiber is coupled within the thin layer of metal and propagates under the form of a wave called surface plasmon. The energy coupling between the optical fiber and the fine layer of metal strongly depends on the refractive index of the substrate covering the layer of metal. Therefore, by using a substrate having a refractive index which strongly varies with a parameter to measure, we can increase the sensor performances.

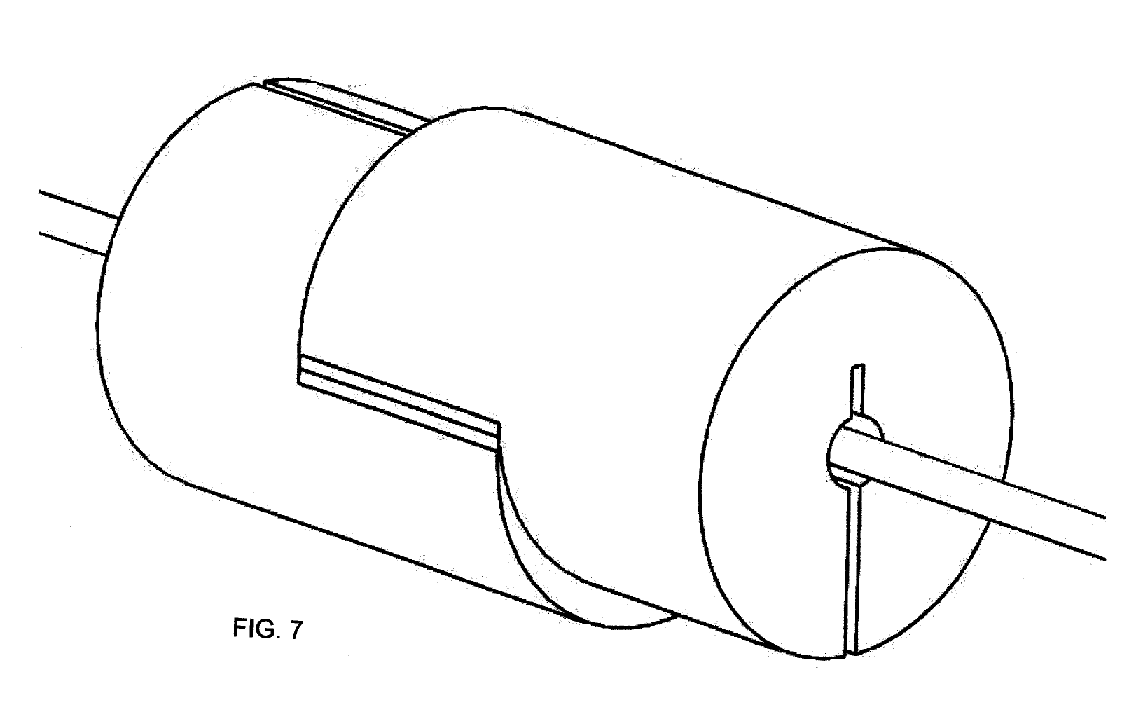

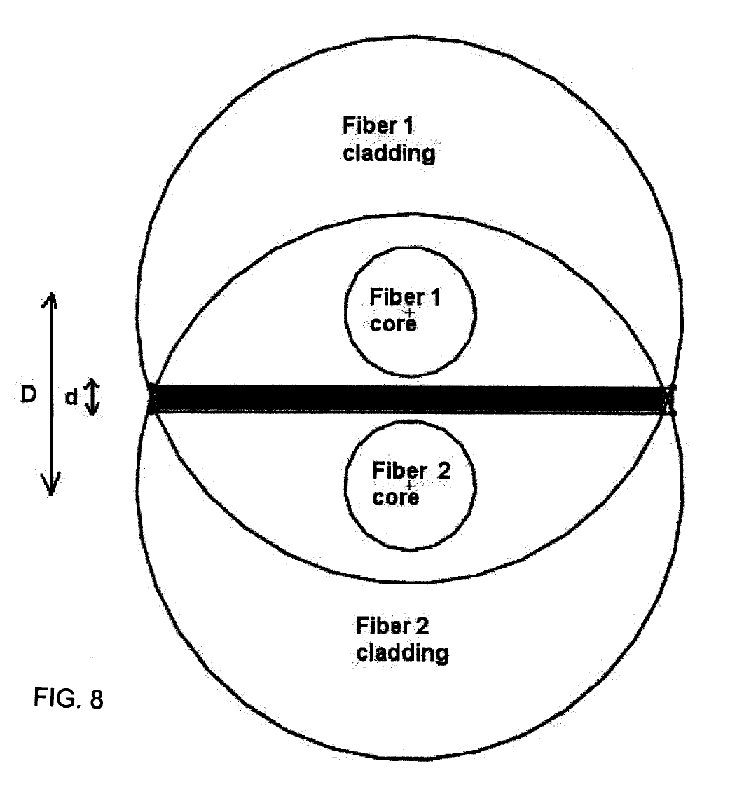

In a further aspect of this invention illustrated in FIGS. 7 and 8, other designs of an evanescent field optical fiber sensor are possible notably by coupling two optical fibers of the present invention having both exposed cladding portions. For example, one could use two sensors as the ones presented in FIG. 2 or 3 and inserts a responsive layer of coating between the two evanescent field optical fiber sensors. Then, we can quantify any desired parameter by measuring the transferred energy between the optical fibers 1 and 2.

Referring now to FIG. 8, the substrate between the two evanescent field optical fiber sensors is illustrated in black. This substrate is specifically chosen to present a variation of its refractive index in relation with the parameter to measure. The variation in its refractive index will induce variation in the spatial distribution of the evanescent field. Moreover, the variation of the density of the substrate will induce variation in the thickness d of the substrate which will modify the distance D between the core 1 and the core 2. The coupling coefficient between the two optical fibers and the signal transferred from the guide 1 to the guide 2 are thus affected. The measure and the analysis of the signal transmitted from the optical fiber 2 allow the determination of the value of the studied parameter.

Furthermore, one would understand that it is possible to apply the same principle as described above to an optical fiber having a multitude of cores. For example, if an optical fiber has two cores, the dilation and the modification of the refractive index of the substrate would alter the coupling between the four cores.

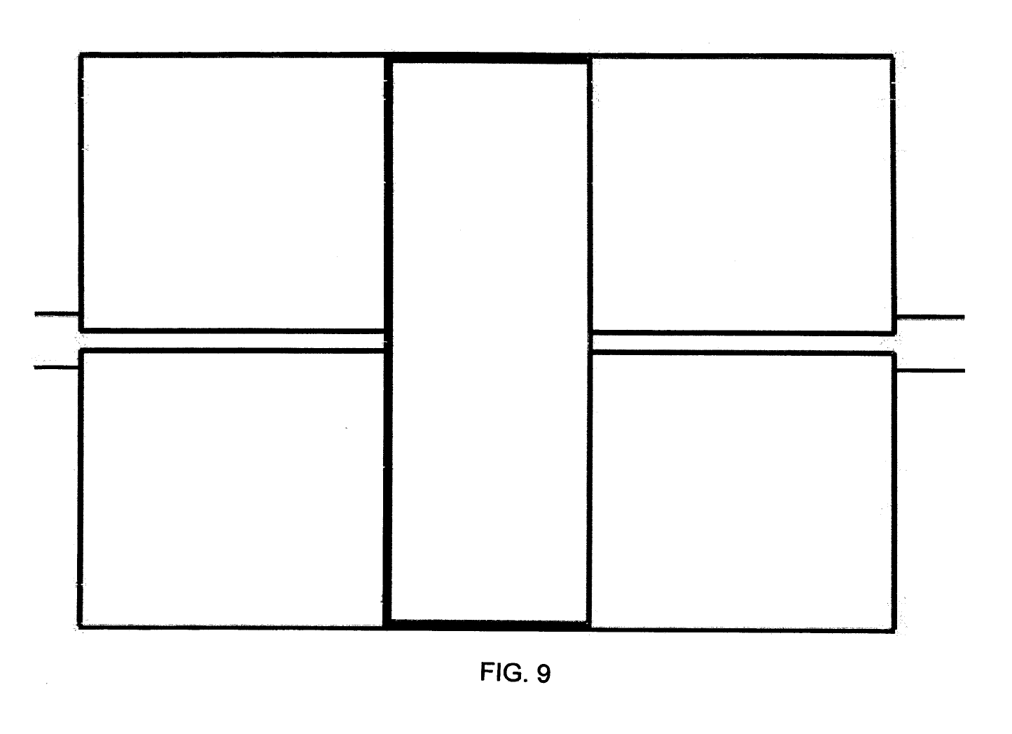

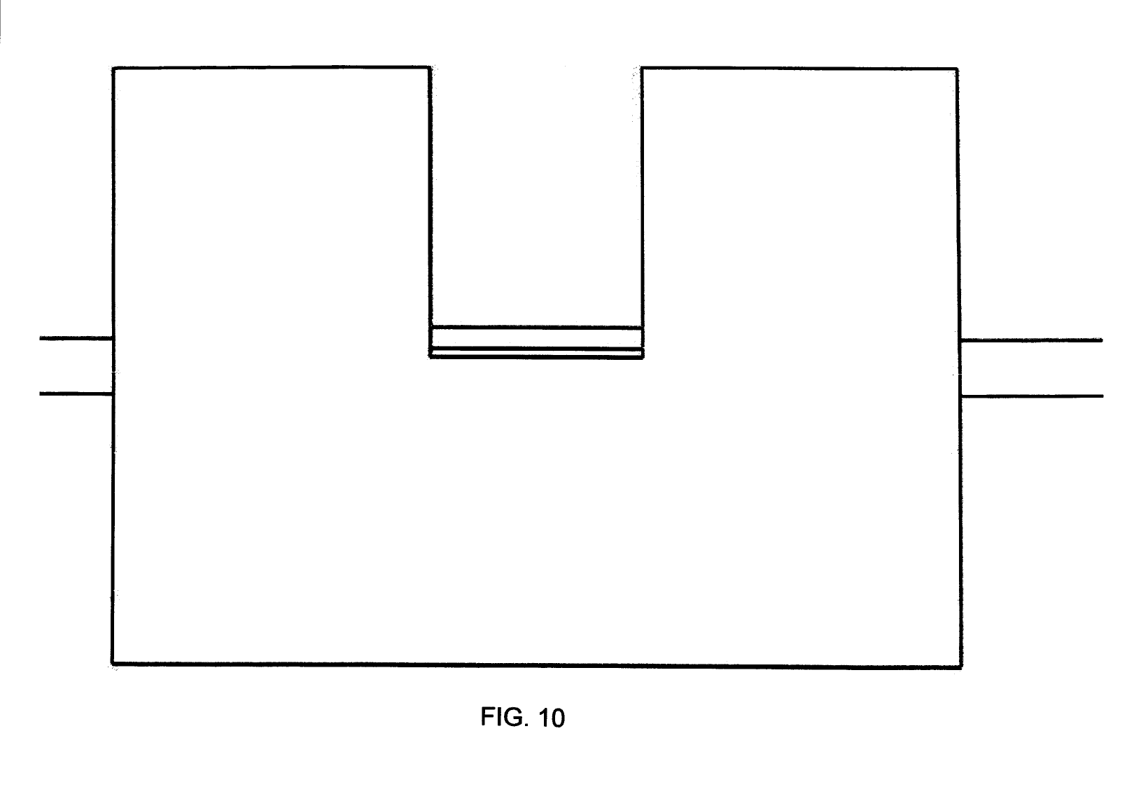

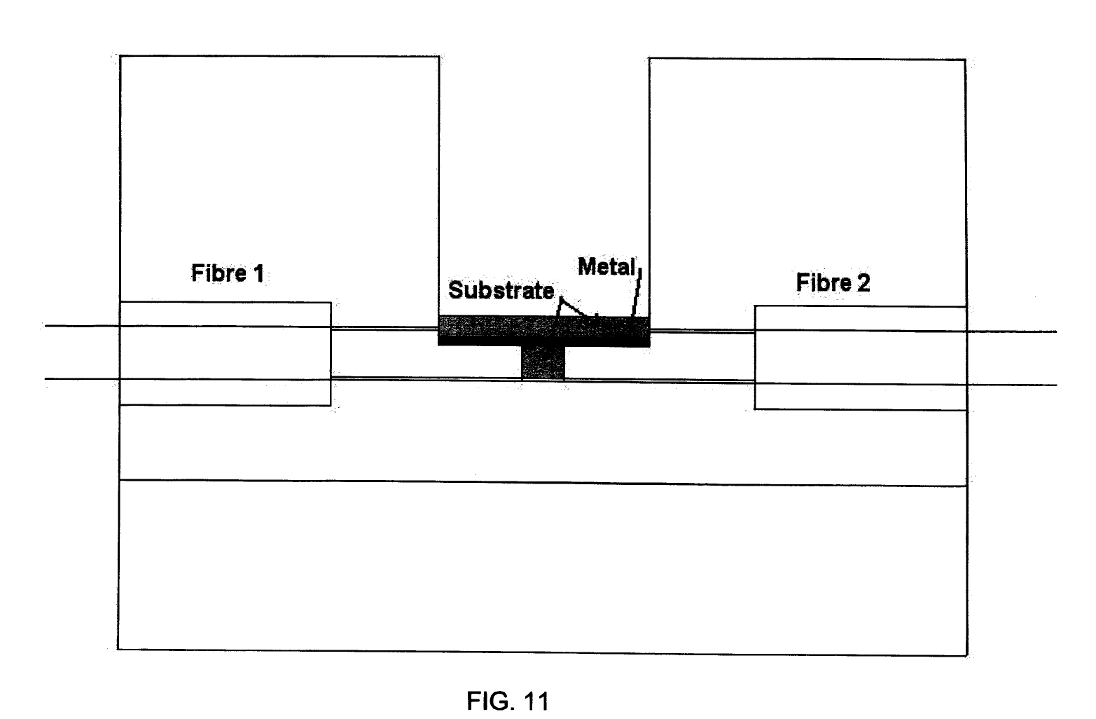

In a further embodiment illustrates in FIGS. 9 to 11, is proposed coupling of two optical fibers by the addition of a plasmonic guide. In this embodiment, two optical fibers are inserted within a same support, the extremities of the optical fibers not touching each other. The addition of a thin layer of metal and a substrate between the extremities of the two fibers, as illustrated, will allow absorption of the energy of the first optical fiber by the plasmonic guide and the coupling of this energy towards the second optical fiber. In choosing a substrate that responds with the parameter being studied, the analysis of this coupling will allow the quantification of the studied parameters.

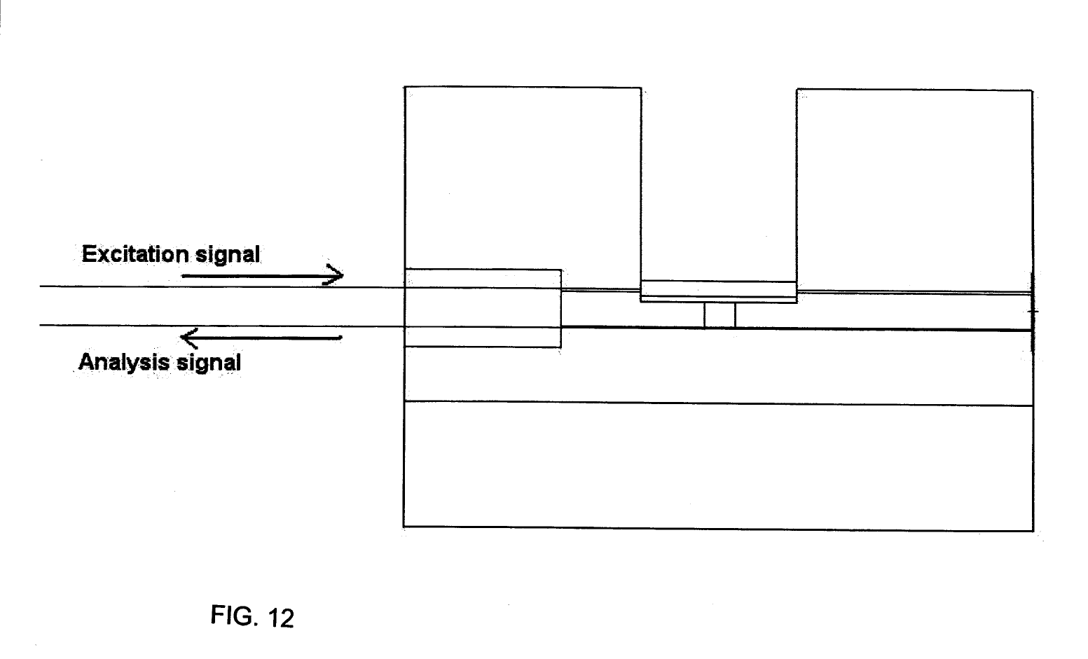

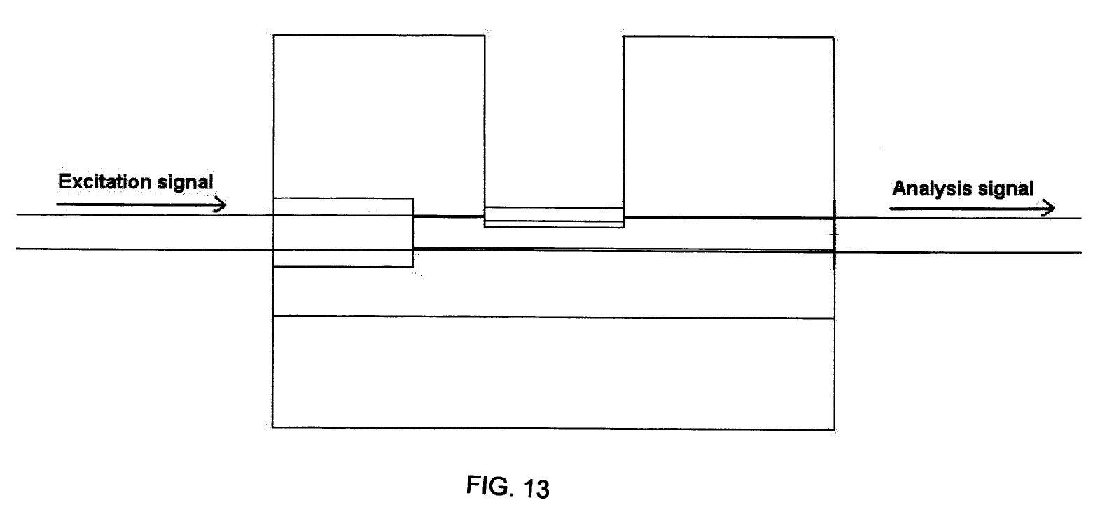

Turning now to FIGS. 12 and 13, there are shown further embodiments with respect to evanescence based optical fiber sensor design. More particularly, FIGS. 12 and 13 represent the evanescence based optical fiber sensor design of the present invention relying on reflection or transmission, respectively.

Firstly, for the design based on reflection (FIG. 12), the excitation signal arrives by an optical fiber, passes through the evanescence based optical fiber sensor, is reflected when reaching the interface fiber-air, comes back by the sensor and the fiber to be further analyzed. The excitation signal must be separated from the analysis signal. This could be done by any known techniques in the art such as, for example, the insertion of a separation cube.

Secondly, regarding the design based on transmission, it is possible to connect several evanescent field optical fiber sensors in series along a single optical fiber to obtain different information from each of the sensors.

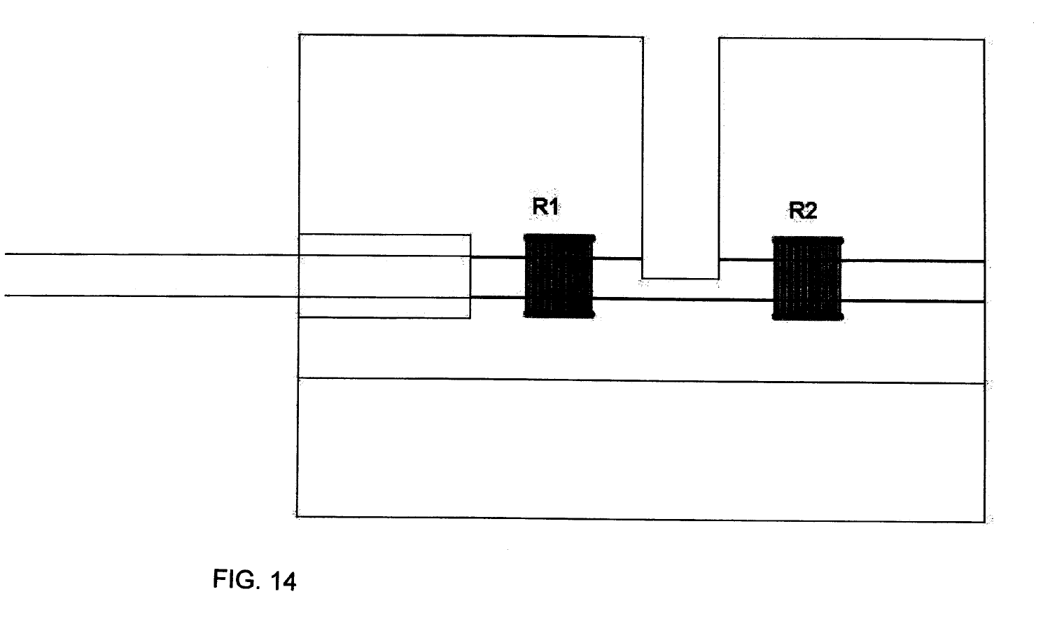

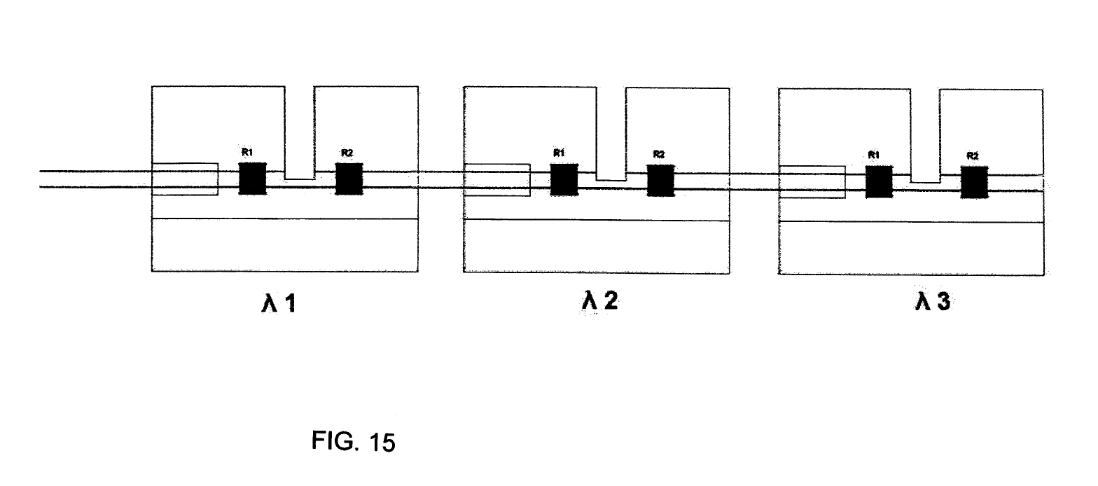

Moreover, the addition of Bragg grating within the fiber before and after the active zone allows a significant augmentation of the sensitivity of the device in order to obtain usable values. The Bragg grating reflects particular wavelengths of light and transmits all others. This is clearly illustrated in FIGS. 14 and 15 which show a design in reflection and a design in transmission.

Polychromatic light travels within an optical fiber as an excitation signal. The variation in absorption of the evanescent wave is generated by the variation of the studied parameter. This absorption strongly depends from the excitation signal wavelength, i.e. the detection of a certain parameter is related to a specific wavelength while the detection of another parameter requires another wavelength. The Bragg grating allows the desired wavelength to be reflected according to the Bragg conditions while allowing the other wavelength to continue as transmitted in the fiber including to other sensors. The value of interest to be measured by each individual sensor is captured and recovered by analysis of the wavelength corresponding to the value associate with a particular sensor.

In a further embodiment, a device such as shown in FIG. 6 can be used for the polarization of the light which travels within an optical fiber in absorbing all the energy which is in a polarization state. The application of an active control of the refractive index by a specific manner would allow the active control of the polarization which travels within an optical fiber.

Furthermore, in order to rapidly and easily control the transmitted power within an optical fiber, it would be appreciated that the device of the present application could also be used as an attenuator in order to attenuate the signal travelling within the fiber. Similarly, it could also be used as a commutator.

It will be understood by the skilled person, that number of the grooves, the dimension and sizing of the grooves and the spatial orientation and the spacing between the grooves from each other can all be accomplished by known mechanical or chemical means. The skilled person would know how to select the appropriate components (optical fibers, substrate, Bragg grating, wavelength, support material, etc) for the purpose of putting the present invention into practice as described herein.

It will also be appreciate that these types of evanescence based optical fiber sensors comprising of a support with optical fiber all as described herein can be fabricated to have utility in extreme conditions such as a harsh fluid stream or under other harsh physical conditions, for example in measurement of fractional streams in petroleum or chemical processing; or extractions; aeronautic and aerospace applications and military applications including in detection of dangerous chemical and biological agents.

Further, it will be appreciated from the above description that the present invention may include all kinds of optical fibers devices such as couplers, splitters, repeaters, switchers, amplifiers, attenuators, isolators and the like.

While the above description constitutes the preferred embodiments, it will be appreciated that the present invention is susceptible to modification and change without departing from the fair meaning of the accompanying claims.

1. An optical fiber support comprising:
a body made of an elastically deformable material;
a fiber conduit extending along a longitudinal axis of the body from a first end of the body to a second end of the body;
a slot extending longitudinally from the first end to the second end and transversally from the fiber conduit to an outer surface of the body, the slot allowing expansion of the fiber conduit for insertion of an optical fiber; and
an access groove formed in the body, the groove extending from the outer surface of the body into the fiber conduit.

2. The optical fiber support as claimed in claim 1 wherein a distance between a bottom of the groove and a central longitudinal axis of the fiber conduit is greater than a radius of a core of an optical fiber to be supported within the optical fiber support.

3. The optical fiber support as claimed in claim 1 wherein the groove is centrally disposed within the body such that the groove is spaced inwardly from both the first end and the second end.

4. The optical fiber support as claimed in claim 1 wherein the groove extends inwardly from one end of the body.

5. The optical fiber support as claimed in claim 1 wherein the body is made of a shape memory alloy.

6. The optical fiber support as claimed in claim 1 wherein the groove is orthogonal to the slot.

7. The optical fiber support as claimed in claim 1 wherein the body is cylindrical.

8. The optical fiber support as claimed in claim 1 wherein the slot extends beyond the fiber conduit to facilitate opening of the slot and fiber conduit.

9. A method of gaining access to an evanescent field emanating from an optical fiber, the method comprising:
providing an optical fiber support comprising:
a body made of an elastically deformable material;
a fiber conduit extending along a longitudinal axis of the body from a first end of the body to a second end of the body; and
a slot extending longitudinally from the first end to the second end and transversally from the fiber conduit to an outer surface of the body, the slot allowing expansion of the fiber conduit for insertion of an optical fiber; and
cutting an access groove into the body, the groove extending from the outer surface of the body into the fiber conduit.

10. The method as claimed in claim 9 further comprising positioning the optical fiber into the support prior to cutting the access groove whereby cutting the access groove comprises also cutting a cladding of the fiber in the support.

11. The method as claimed in claim 9 further comprising positioning the optical fiber into the support after cutting the access groove and then subsequently cutting a cladding of the optical fiber supported in the support.

12. The method as claimed in claim 9 wherein the groove is cut to a depth wherein a distance between a bottom of the groove and a central longitudinal axis of the fiber conduit is greater than a radius of a core of the optical fiber to be supported within the optical fiber support.

13. The method as claimed in claim 9 wherein the groove is cut orthogonally to the slot.

14. The method as claimed in claim 9 further comprising:
adding a thin layer of metal over an exposed surface of the cladding; and
applying a substrate over the thin layer of metal.

15. An evanescent field optical fiber sensor for sensing a change in an evanescent field emanating from light propagating through an optical fiber, the optical fiber sensor comprising:
an optical fiber support having:
a body made of an elastically deformable material;
a fiber conduit extending along a longitudinal axis of the body from a first end of the body to a second end of the body;
a slot extending longitudinally from the first end to the second end and transversally from the fiber conduit to an outer surface of the body, the slot allowing expansion of the fiber conduit for insertion of an optical fiber; and
an access groove formed in the body, the groove extending from the outer surface of the body into the fiber conduit; and
an optical fiber supported in the fiber conduit of the optical fiber support, a cladding of the fiber being cut to provide access to the evanescent field emanating from the optical fiber.

16. The sensor as claimed in claim 15 wherein a distance between a bottom of the groove and a central longitudinal axis of the fiber conduit is greater than a radius of a core of the optical fiber supported within the optical fiber support.

17. The sensor as claimed in claim 15 wherein the groove is orthogonal to the slot.

18. The sensor as claimed in claim 15 further comprising:
a thin layer of metal disposed over an exposed surface of the cladding; and
a substrate disposed over the thin layer of metal.

19. The sensor as claimed in claim 15 further comprising a substrate disposed over an exposed surface of the cladding, the substrate having optical properties that vary with a parameter to be sensed.

20. The sensor as claimed in claim 15 comprising two optical fiber supports, each optical fiber support supporting a respective optical fiber, each of the two optical fiber supports having a respective groove extending inwardly into the body from one end of the body, one of the two optical fiber supports being inverted relative to the other one of the two optical fiber supports on either side of a substrate that is sandwiched between flat surfaces of the grooves whereby the optical fibers supported by the supports are aligned substantially parallel and in close proximity to one another to enable light to be coupled from one optical fiber into the other optical fiber through the substrate.

21. The sensor as claimed in claim 15 comprising two optical fibers held within the same support, the groove in the support having a plasmonic guide comprising a thin metal layer interposed between the optical fibers and a substrate disposed within the groove above the thin metal layer.

22. The sensor as claimed in claim 15 comprising a single optical fiber for carrying an excitation signal and a reflected analysis signal for sensing optical properties of a substrate placed in the groove.

23. The sensor as claimed in claim 15 comprising first and second optical fibers held within the same support, the groove of the support holding a substrate whose optical properties are to be sensed, the first fiber carrying an excitation signal to the substrate while the second fiber carrying the analysis signal propagating away from the substrate.

24. The sensor as claimed in claim 15 further comprising a Bragg grating for selectively transmitting light of one or more predetermined wavelengths through the Bragg grating to the substrate to enable measurement of a variance in the optical properties of the substrate using the one or more predetermined wavelengths.

25. The sensor as claimed in claim 15 further comprising first and second Bragg gratings, the first Bragg grating being disposed before the groove and substrate and the second Bragg grating being disposed beyond the groove and substrate, the first Bragg grating selectively transmitting light of one or more predetermined wavelengths through the Bragg grating to the substrate to enable measurement of a variance in the optical properties of the substrate using the one or more predetermined wavelengths, the second Bragg grating reflecting the one or more predetermined wavelengths back to the substrate to thereby increase a sensitivity of the measurement of the optical properties of the substrate.

26. A method of measuring a parameter by sensing an evanescent field emanating from an optical fiber, the method comprises:
providing an optical fiber support comprising:
a body made of an elastically deformable material;
a fiber conduit extending along a longitudinal axis of the body from a first end of the body to a second end of the body; and
a slot extending longitudinally from the first end to the second end and transversally from the fiber conduit to an outer surface of the body, the slot allowing expansion of the fiber conduit for insertion of an optical fiber; and
an access groove in the body, the groove extending from the outer surface of the body into the fiber conduit;
placing an optical fiber in the groove;
placing in the groove a substrate having an optical property that varies with a physical parameter to be measured; and
measuring the physical parameter by sensing a variance in the evanescent field.

27. The method as claimed in claim 26 comprising transmitting an excitation signal down a single fiber that carries back the reflected analysis signal.

28. The method as claimed in claim 26 comprising transmitting an excitation signal along a first fiber and propagating an analysis signal along a second fiber.

29. The method as claimed in claim 26 comprising filtering wavelengths using a Bragg grating.

30. The method as claimed in claim 26 comprising filtering wavelengths using a first Bragg grating disposed before the groove and substrate for blocking all but one or more predetermined wavelengths and a second Bragg grating disposed beyond the groove and substrate for reflecting the one of more predetermined wavelengths back to the substrate.
